(19) United States
(12) Patent Application Publication
(10) Pub. No.: US 2006/0285458 A1
(43) Pub. Date: Dec. 21, 2006

(54) Optical writing apparatus and method of setting write power thereof

(76) Inventor: Yukihisa Nakajo, Yokahama-si (JP)

Correspondence Address: LEE & MORSE, P.C., 3141 FAIRVIEW PARK DRIVE, SUITE 500, FALLS CHURCH, VA, 22042, US

(21) Appl. No.: 11/452,396

(22) Filed: Jun. 14, 2006

(30) Foreign Application Priority Data
Jun. 15, 2005 (JP) 2005-174991

(51) Int. Cl. G11B 7/12

(52) U.S. Cl. 369/47.51

(57) ABSTRACT

An optical writing apparatus that can set a write power for recording information on an optical recording medium and a method of setting a write power thereof are provided. The method of setting a write power of the optical writing apparatus includes calculating a first deviation between a theoretical length and a written length of each mark when applying a first power ratio, calculating a second deviation between a theoretical length and a written length of each mark when applying a second power ratio, and estimating the deviation at a power ratio other than the first and second power ratios, based on the first deviation values and second deviation values. Variance values of deviations at each power ratio may be determined from the calculated deviations and the estimated deviation. A write power may be set by applying a power ratio corresponding to a minimum variance value among the variance values.

### BACKGROUND OF THE INVENTION

1. Field of the Invention

The present invention relates to an optical information recording apparatus. More particularly, the present invention relates to an optical writing apparatus that can set a write power for recording information on an optical recording medium, and a method of setting the write power thereof.

2. Description of the Related Art

As internet use has rapidly become widespread, due to recent developments in information communication technologies, a huge amount of information is now exchanged through networks. Accordingly, write-once optical disks, such as a CD-R, and rewritable optical disks, such as a CD-RW, have been highlighted as recording media for information writing apparatuses.

As the wavelength of light sources used with optical disks has been shortened, a spot diameter has been reduced using an objective lens having a high numerical aperture (NA) and thin substrates have been employed, allowing high-capacity optical disks to be realized. High capacity optical disks, e.g., DVD±R, DVD±RW and DVD-RAM, are now in wide use as information recording media.

Generally, when information is recorded on an optical disk, such as a CD-R, recording information, e.g., from a personal computer (PC), is converted into an eight-to-fourteen modulation (EFM) signal and then is recorded on the optical disk. However, due to different compositions in color recording layers forming the optical disk, thermal storage or cooling rates of the optical disk may be insufficient to prevent data features from being formed without defects. As a result, although the EFM signal is recorded without any change, desired data features, e.g., marks/spaces or pits/lands, cannot be accurately formed.

In order to solve this problem, a high write quality may be maintained by setting a recording parameter (hereinafter referred to as “a write strategy”) unique to an individual optical disk, with respect to a reference write waveform. Representative write strategies include varying the ratio of marks and spaces, adding an additional pulse to the front end of a writing pulse, changing a rising or falling position of a pulse with a combination of a mark and a space, and converting a write pulse into multiple pulses.

Write strategies are also dependent on a recording speed as well as the color of the optical disk, phase change material, thickness of a color film or shape of a groove. Accordingly, a write strategy may be defined for each optical recording medium or each writing speed.

For example, for a write operation on a DVD-R, performed at a speed four times higher that for a write operation on CD, a castle-type write strategy illustrated in FIG. 1 may be used.

In the castle-type write strategy, a castle-shaped pulse, in which the central part of the write pulse is lower than either edge of the write pulse, is used for a mark with a length of 5 T˜14 T. The level of this castle-shaped pulse is determined by a top power (Po) defining the level of the pulse and a middle power (Pm) defining the level of the lower, center part.

The 5 T˜14 T length of the write mark is highly influenced by the total area of the castle-shaped pulse. Thus, a ratio of the top power (Po) to the middle power (Pm) has a direct influence on the shape of a mark to be formed. Accordingly, how to set a ratio of the top power (Po) to a middle power (Pm) is an important issue directly related to recording quality.

FIG. 2 illustrates a method of determining the ratio (Po/Pm) according to a conventional technology.

According to the conventional technology, in the case of a fixed write strategy or constant top power (Po), recording of information is performed while the ratio of the top power (Po) to a middle power (Pm) is varied, and reproduction jitters are obtained as illustrated in FIG. 2. Then, a ratio of the top power (Po) to the middle power (Pm) having a minimum jitter value is determined. Also, the value of the top power (Po) or the middle power (Pm) is defined based on a level (bias power Pb) used in servo control or reading information. Accordingly, if the bias power (Pb) changes, the top power (Po) or the middle power (Pm) changes relative to the bias power (Pb) and the recording quality is deteriorated. To prevent this deterioration, changing a middle power (Pm) with respect to the change of a bias power (Pb) has been suggested.

However, to change the ratio of the top power (Po) to the middle power (Pm) in the fixed write strategy, numerous data should be written on an optical recording medium, jitter values should be obtained by reproducing the data, and the obtained jitter values should be interpreted in order to determine the ratio (Po/Pm) of the top power (Po) to the middle power (Pm). Accordingly, a lot of time is needed to determine an optimum ratio (Po/Pm) of the top power (Po) to the middle power (Pm).

When the ratio (Po/Pm) is set in an optical writing and reproducing apparatus, a method of writing much data and finding an optimum value based on the written data is limited by a capacity of an optical recording medium, since the capacity of test area regions in an inner circumference and an outer circumference on the optical recording medium are generally limited.

In addition, while changing the middle power (Pm) with respect to change of the bias power (Pb) may reflect the change of the bias power (Pb), but it fails to address setting an optimum ratio of the top power (Po) to the middle power (Pm), which is also needed to maintain recording quality. Thus, a method solving this problem is still needed.

### SUMMARY OF THE INVENTION

The present invention is therefore directed to providing an optical information writing apparatus and method, which overcome one or more of the disadvantages of the related art.

It is therefore a feature of an embodiment of the present invention to provide an optical information writing apparatus that can set a write power for each optical recording medium in a short time, and a method of setting the write power of the optical writing apparatus.

It is therefore another feature of an embodiment of the present invention to provide an optical information writing apparatus that can set a write power for each optical recording medium by at least two information recording and reproducing operations with varying power ratios, and a method of setting the write power of the optical writing apparatus.

At least one of the above and other features and advantages of the present invention may be realized by providing an optical writing apparatus for writing information on an optical recording medium using one of a write pulse having a first power level and a write pulse having a pulse in which the central part of the pulse has a second power level lower than the first power level, the apparatus including a light source driving unit outputting, when at least two different power ratios of the first power level to the second power level are set, a pulse signal according to each power ratio to the light source for driving the light source, a deviation calculation unit calculating, when a write pulse to which each of the at least two different power ratios is applied is directed onto the optical recording medium, a deviation for each mark with respect to each of the at least two different power ratios between a desired theoretical length of the mark and an actually formed written length of the mark, and a control unit estimating a deviation of a power ratio, other than the at least two different power ratios, for each mark based on calculated deviations from the deviation calculation unit with respect to each of the at least two different power ratios.

The apparatus may include a variance calculation unit calculating the variance value of the deviation at each power ratio from the calculated deviations by the deviation calculation unit and estimated deviations by the control unit, and a write power setting unit setting the first power level and the second power level by applying a power ratio corresponding to a minimum variance value among the calculated variance values.

The control unit may estimate the deviation at the power ratio other than the at least two different power ratios by performing a linear interpolation based on the calculated deviations by the deviation calculation unit With respect to each of the at least two different power ratios. The linear interpolation may include weighting the deviations in accordance with a probability of occurrence of a mark.

At least one of the above and other features and advantages of the present invention may be realized by providing a method of setting a write power for an optical writing apparatus for writing information on an optical recording medium using one of a write pulse having a first power level and a write pulse having a pulse in which the central part of the pulse has a second power level lower than the first power level, the method including setting a first power ratio of the first power level to the second power level, directing a write pulse corresponding to the first power ratio onto the optical recording medium, calculating, for each mark, first deviation values between a desired theoretical length of the mark and an actually formed written length of the mark, setting a second power ratio of the first power level to the second power level, directing a write pulse corresponding to the second power ratio onto the optical recording medium, calculating, for each mark, second deviation values between a theoretical length of the mark and a written length of the mark, estimating the deviation for each mark at a power ratio other than the first and second power ratios based on the first deviation values and the second deviation values, calculating a variance value of the deviation at each power ratio, and setting the first power level and the second power level by applying a power ratio corresponding to a minimum variance value among the calculated variance values.

The estimating may include performing a linear interpolation based on the first deviation values and the second deviation values. The linear interpolation may include weighting the deviations in accordance with a probability of occurrence of a mark.

At least one of the above and other features and advantages of the present invention may be realized by providing an article of manufacture having a machine-accessible medium including data that, when accessed by a machine, cause the machine to operate an optical information recording apparatus for writing information on an optical recording medium using one of a write pulse having a first power level and a write pulse light having a pulse in which the central part of the pulse has a second power level lower than the first power level, the operation including setting a first power ratio of the first power level to the second power level, directing a write pulse corresponding to the first power ratio onto the optical recording medium, calculating, for each mark, first deviation values between a desired theoretical length of the mark and an actually formed written length of the mark, setting a second power ratio of the first power level to the second power level, directing a write pulse corresponding to the set second power ratio onto the optical recording medium, calculating, for each mark, second deviation values between a theoretical length of the mark and a written length of the mark, estimating the deviation for each mark at a power ratio other than the first and second power ratios based on the first deviation values and the second deviation values, calculating a variance value of the deviation at each power ratio, and setting the first power level and the second power level by applying a power ratio corresponding to a minimum variance value among the calculated variance values.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a castle-type write strategy according to a conventional technology;

FIG. 2 illustrates a method of determining the ratio (Po/Pm) of the top power (Po) to the middle power (Pm) according to a conventional technology;

FIG. 3 illustrates a deviation at each mark when the ratio (Po/Pm) of the top power (Po) to the middle power (Pm) is set according to an embodiment of the present invention;

FIG. 4 schematically illustrates FIG. 3 when the ratio (Po/Pm) of the top power (Po) to the middle power (Pm) and the deviation at each mark are in a linear relationship according to an embodiment of the present invention;

FIG. 5 illustrates the relation between a variance value and a jitter value based on measured values according to an embodiment of the present invention;

FIG. 6 illustrates a block diagram of an optical writing apparatus according to an embodiment of the present invention;

FIG. 7 illustrates a flowchart of a method of setting a write power of an optical writing apparatus according to an embodiment of the present invention; and

FIG. 8 illustrates the effect of an embodiment of the present invention.

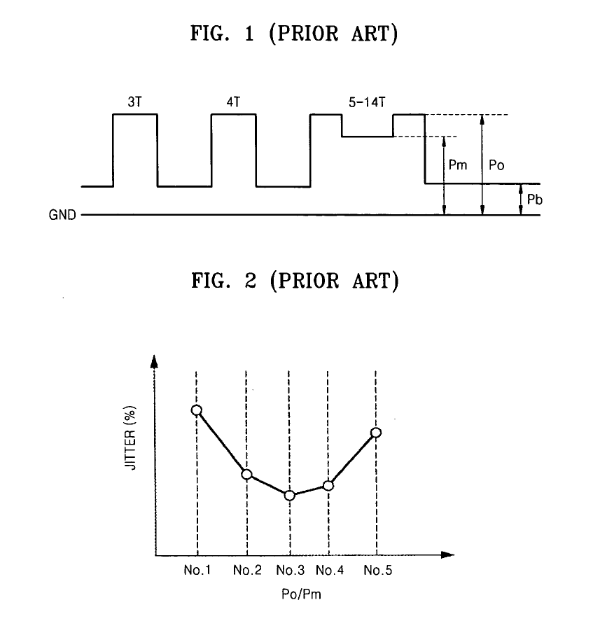

### DETAILED DESCRIPTION OF THE INVENTION

Japanese Patent Application No. 2005-174991, filed on Jun. 15, 2005, in the Japan Patent Office, and entitled: “Optical Writing Apparatus and Method of Setting Write Power Thereof,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. Like reference numerals refer to like elements throughout.

In an optical writing apparatus according to the present invention, when a ratio (Po/Pm) of a top power (Po) to a middle power (Pm) is changed, a deviation between a theoretical length, i.e., a length desired to be formed by a write operation, and a written length, i.e., a length actually formed by a write operation, of each mark may be calculated, a variance value of the calculated deviation may be obtained, and a write power may be set so that the write power corresponds to the ratio (Po/PM) having a minimum variance value. In order to set the write power, the present invention uses the fact that when the ratio (Po/Pm) is changed, the changed quantity of the deviation of the theoretical length and the written length of each mark is roughly proportional, e.g., linearly proportional, to the changed quantity of the ratio (Po/Pm).

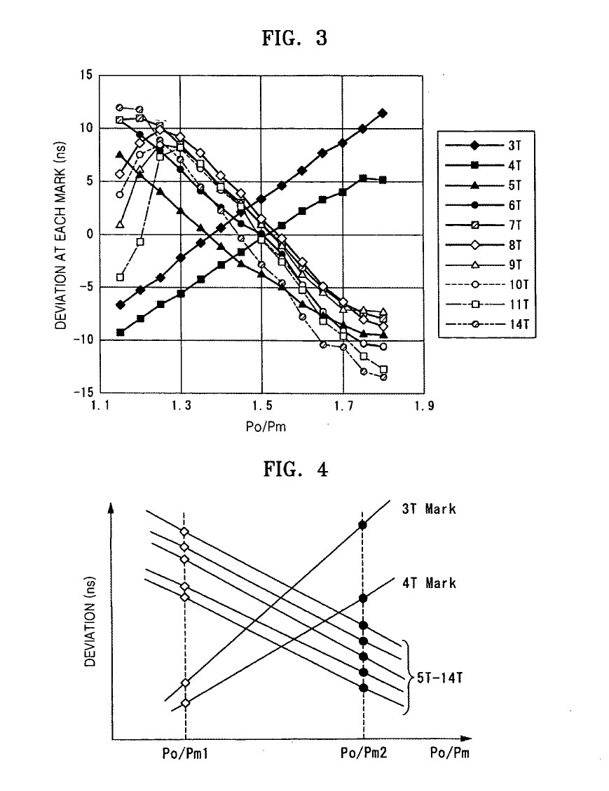

Before explaining details of the optical writing apparatus according to the present invention, assumptions regarding the optical writing apparatus will now be explained with reference to FIGS. 3 through 5.

FIG. 3 illustrates a deviation at each mark when the ratio (Po/Pm) is set according to an embodiment of the present invention. As can be seen in FIG. 3, an approximately linear relationship exists between the ratio (Po/Pm) and the deviation at each mark.

FIG. 4 schematically illustrates FIG. 3 when the ratio (Po/Pm) and the deviation at each mark are in a linear relationship.

The graph of FIG. 4 can be divided into a group from 5 T to 14 T marks having deviations decreasing at the right-hand side with respect to the ratio (Po/Pm), and a group of 3 T and 4 T marks increasing at the right-hand side with respect to the ratio (Po/Pm).

In FIG. 4, the ratio (Po/Pm) increases with an increasing distance from the origin along the horizontal axis. Since a change in the ratio (Po/Pm) is directly related to a change in the shape of a write pulse with respect to 5 T to 14 T marks, the area of a write pulse formed by the write pulse of 5 T to 14 T marks decreases with increasing distance from the origin along the horizontal axis. In FIG. 4, it can be seen that with respect to 5 T through 14 T marks, the deviation between the written length and theoretical length of a mark gradually decreases with increasing distance from the origin along the horizontal axis.

Even though changing the ratio (Po/Pm) does not have a direct influence on the shape of a write pulse with respect to 3 T and 4 T marks, since the total quantity of mark lengths from 3 T to 14 T marks should be the same according to the standard, if the written length of 5 T through 14 T marks changes, the written length of 3 T and 4 T marks also changes. As illustrated in FIG. 4, as the ratio (Po/Pm) increases, the deviation related to 5 T through 14 T marks decreases and the deviation related to 3 T and 4 T marks increases.

In FIG. 3, the characteristic of changes in the deviation at 3 T and 4 T marks can be regarded as nearly liner. While the characteristic of changes in the deviation at 5 T through 14 T marks are not as linear as that at 3 T and 4 T marks, this may be offset by multiplying the deviation of each mark by the probability of the presence of a mark when a deviation and a weighted mean value are calculated, which will be explained later. That is, since the probability of presence of 5 T through 14 T marks is lower than that of 3 T and 4 T marks, by multiplying a deviation by a probability of presence, the effect caused by the decreased linearity of 5 T through 14 T marks can be reduced. The deviation at each mark with respect to the ratio (Po/Pm) can be approximated as linear, as illustrated in FIG. 4. Accordingly, at least two values (Po/Pm1 and Po/Pm2 in FIG. 4) of the ratio (Po/Pm) may be determined and the deviation at each mark may be calculated. Then, by using this approximation, the deviation at each mark at a ratio other than a predetermined ratio can be estimated.

There is also a close relation between a jitter value and the deviation at each mark. Since a jitter relates to the deviation of a mark length and a space length, when a variance value calculated from the deviation at each mark has a minimum value, the jitter value also has a minimum value.

Considering this relationship, a variance (K) of a deviation may be defined using equation 1 and a weighted mean value Avg may be defined using equation 2. In equation 1, Dev(i) is the deviation at iT mark and R(i) is the probability of presence of iT mark. In equation 2, D(mT) is the deviation of mT mark and R(mT) is the probability of presence of mT mark.

$$\begin{matrix}K = {\sum }_{i = 3}^{14} {( {Dev}_{i} - Avg )}^{2} * {R}_{i} & ( 1 ) \\ \begin{matrix}Avg = D ( 3 T ) * R ( 3 T ) + D ( 4 T ) * R ( 4 T ) + … + D ( 14 T ) * R ( 14 T ) \\ = {\sum }_{m = 3}^{14} D ( mT ) * R ( mT )\end{matrix} & ( 2 )\end{matrix}$$

By using the linearity of changes in the deviation with respect to the ratio (Po/Pm), the deviation at each mark with respect to each power ratio (Po/Pm) may be obtained. From the obtained deviation, the variance value of the deviation with respect to each power ratio (Po/Pm) may be obtained using equations 1 and 2. Then, a ratio (Po/Pm) having a minimum variance value may be determined. The ratio (Po/Pm) having the minimum variance value may also be the ratio (Po/Pm) having a minimum jitter value.

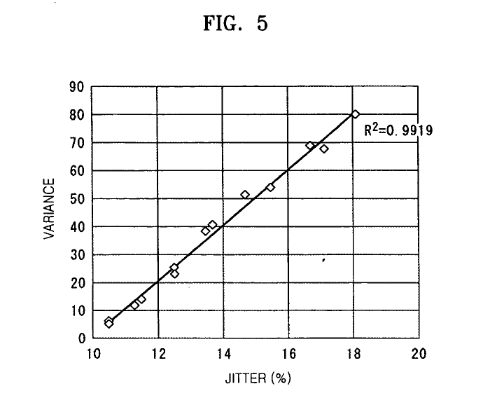

FIG. 5 illustrates the relationship between a variance value and a jitter value based on measured values according to an embodiment of the present invention. R² is the degree of correlation of the variance value and the jitter value. In the example shown in FIG. 5, R² is 0.9919.

Based on the above explanation, an optical writing apparatus according to an embodiment of the present invention will now be described.

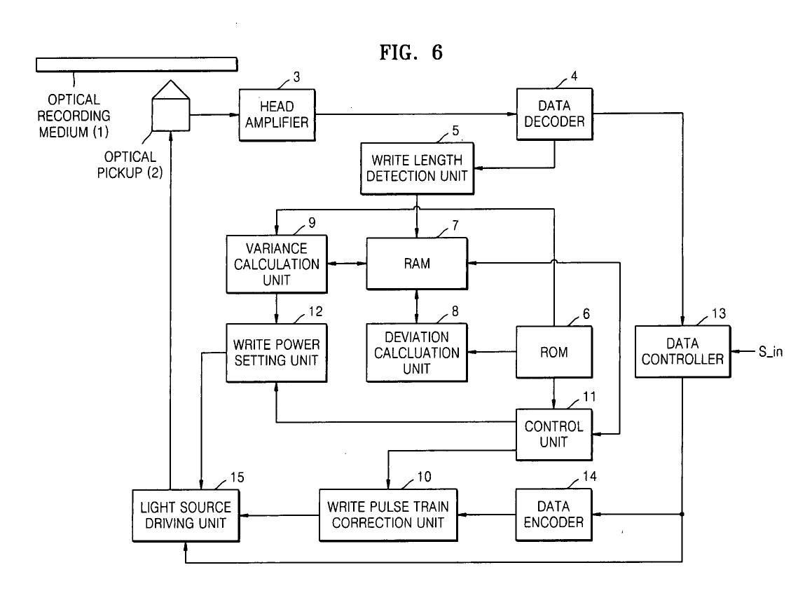

FIG. 6 illustrates a block diagram of an optical writing apparatus according to an embodiment of the present invention.

The optical writing apparatus of FIG. 6 may include an optical recording medium 1, an optical pickup 2 having a light source, a head amplifier 3, a data decoder 4, a written length detection unit 5, a ROM 6, a RAM 7, a deviation calculation unit 8, a variance calculation unit 9, a write pulse train correction unit 10, a control unit 11, a write power setting unit 12, a data controller 13, a data encoder 14 and a light source driving unit 15.

Information may be recorded on the optical recording medium 1, e.g., in the form of marks and spaces, by directing light from a light source, e.g., a semiconductor laser, onto the optical recording medium 1. In an embodiment of the present invention, the optical recording medium is a DVD±R. Although a DVD±R is provided as an example of a rewritable optical recording medium hereinafter, a person skilled in the art of the present invention will appreciate that the present invention can be applied to other optical recording media.

The optical pickup 2 may include a light source (not shown), e.g., a laser diode and other known optical components (not shown). These optical components may include, e.g., a collimating lens, an objective lens driven by a focus actuator or a tracking actuator, a polarized beam splitter, a cylindrical lens, a 4-division photo detector (PD) with four (4) divided regions A, B, C and D, a 2-division PD and/or a monitor detector monitoring light output from the light source.

The head amplifier 3 may detect light reflected from the optical recording medium 1, may calculate the amount of the reflected light and may generate a radio frequency (RF) signal indicating the sum of the light reflected from regions of the 4-division PD. The head amplifier 3 may also generate a focus error signal that indicates misalignment of the focus of light output from the optical pickup 2, by, e.g., an astigmatism method. Furthermore, the head amplifier 3 may generate a tracking error (TE) signal, i.e., a signal detecting track distraction of light output from the optical pickup 2, by, e.g., a push-pull method.

The data decoder 4 may generate an EFM signal from the RF signal generated in the head amplifier 3, may convert the generated EFM signal into a signal of a desired format and may output the signal to the data controller 13.

The written length detection unit 5 may measure the pulse width of the EFM signal input from the data decoder 4 by using a time measuring circuit (not shown). In particular, the written length detection unit 5 may measure the written length of each mark when the ratio (Po/Pm) of a top power (Po) to a middle power (Pm) is changed.

The ROM 6 is a memory device in which data cannot be rewritten, and may store a control program to control the entire optical writing apparatus, a write strategy, a theoretical length of each mark, and a probability of presence of each mark.

The RAM 7 is a memory device in which data can be rewritten, and may temporarily store the result of measuring a written length input from the written length detection unit 5, and a deviation value between a measured written length and a theoretical length.

The deviation calculation unit 8 may calculate the deviation at each mark from the measured values of written lengths stored in the RAM 7 and the theoretical length values stored in the ROM 6.

The variance calculation unit 9 may calculate the variance value of the deviation at each power ratio (Po/Pm) by using a predetermined formula.

The control unit 11 may control the entire optical writing apparatus according to the control program stored in the ROM 6. The control unit 11 may perform straight line interpolation of the deviation at each mark calculated by applying at least two power ratios (Po/Pm), respectively, and thus, may estimate a deviation value when a ratio other than measured ratios is applied. The estimated deviation value may be stored in the RAM 7. Also, the control unit 11 may receive variance values from the RAM 7 calculated by the variance calculation unit 9 and may determine a ratio (Po/Pm) of a top power (Po) to a middle power (Pm) having a minimum variance value.

The write power setting unit 12 may set a write power based on the ratio (Po/Pm) of a top power (Po) to a middle power (Pm) input from the control unit 11, and may output the set write power to the light source driving unit 15.

The data controller 13 may provide an input write signal (S_in) to the data encoder 14, and may read the write signal from the data decoder 14.

The data encoder 14 may convert the input write signal (S_in) from the data controller 13 into an EFM signal or other signal and may output the converted signal to the write pulse train correction unit 10.

The write pulse train correction unit 10 may receive an input of an EFM signal from the data encoder 14 and may generate a write pulse train based on the write strategy input from the control unit 11. The generated write pulse train may be output to the light source driving unit 15.

The light source driving unit 15 may generate a pulse signal for driving a light source corresponding to the write pulse train input from the write pulse train correction unit 10 based on the write power input from the write power setting unit 12. The generated pulse signal for driving a light source may be input to the light source (not shown) in the optical pickup 2. Light from the light source in the optical pickup 2 may be directed onto the optical recording medium 1 in accordance with the pulse signal for driving a light source, and marks and spaces corresponding to the write pulse light may be formed on the optical recording medium 1.

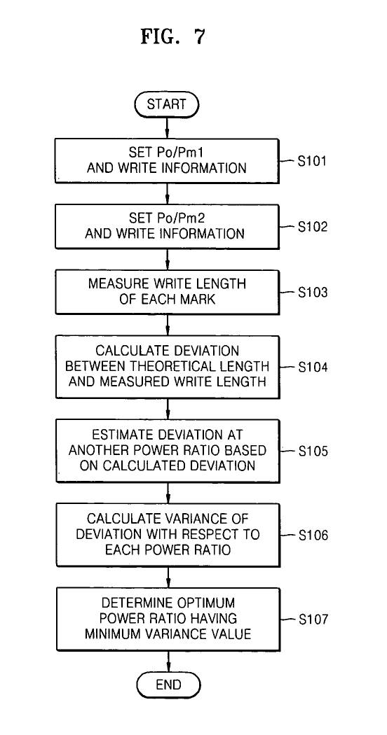

FIG. 7 illustrates a flowchart of a method of setting a write power of an optical writing apparatus according to an embodiment of the present invention.

First, the control unit 11 may output a control signal to the write power setting unit 12 so that the ratio (Po/Pm) of the top power (Po) to the middle power (Pm) may be set to a first power ratio (Po/Pm1 in FIG. 7). In response to the control signal from the control unit 11, the write power setting unit 12 may set the ratio (Po/Pm) to the first power ratio (Po/Pm1), and may output information on a write power corresponding to the first power ratio (Po/Pm1) to the light source driving unit 15. The write pulse train correction unit 10 may generate a write pulse train based on the write strategy and may output generated write pulse train to the light source driving unit 15. The light source driving unit 15 may output a pulse signal for driving a light source corresponding to the write pulse train to the light source in the optical pickup 2. The light source may illuminate the optical recording medium 1 with a write pulse light corresponding to the pulse signal for driving the light source such that a write operation to record marks and spaces is performed in operation S101.

Next, the ratio (Po/Pm) is set to a second power ratio (Po/Pm2 in FIG. 7) that is different from the first power ratio (Po/Pm1) and the same process as in operation S101 may be performed again in operation S102.

Next, the marks and spaces recorded by applying the first power ratio (Po/Pm1) and the second power ratio (Po/Pm2) may be reproduced. A reproduced signal may be input to the written length detection unit 5 through the head amplifier 3 and the data decoder 4, and the written length of each mark from 3 T to 14 T marks may be detected. The detected written length values are stored in a predetermined area of the RAM 7 in operation S103.

Next, the deviation calculation unit 8 may read the written length of each mark from 3 T to 14 T marks from the RAM 7 and the theoretical length of each mark from 3 T to 14 T marks from the ROM 6, and may calculate deviation values between the written length and the theoretical length at each mark from 3 T to 14 T marks. The calculated deviation values may be stored in a predetermined area of the RAM 7 in operation S104.

Next, the control unit 11 may read a deviation value corresponding to the first power ratio (Po/Pm1) and the second power ratio (Po/Pm2) from a predetermined area of the RAM 7, and may perform linear interpolation or extrapolation from 3 T to 14 T marks. Then, the control unit 11 may estimate a deviation corresponding a power ratio (Po/Pm) other than the first power ratio (Po/Pm1) and the second power ratio (Po/Pm2) based on the result of the linear interpolation or extrapolation, may relate the estimated deviation value to the power ratio (Po/Pm), and may store the estimated deviation value in a predetermined area of the RAM 7 in operation S105.

Next, the variance calculation unit 9 may read the deviation at each mark from 3 T to 14 T marks related to the power ratio (Po/Pm) from the RAM 7, may read the probability of presence of each mark from 3 T to 14 T from the ROM 6, and by using equations 1 and 2, may calculate the variance value of the deviation at each power ratio (Po/Pm). The calculated variance values may be stored in a predetermined area of the RAM 7 in operation S106.

Next, the control unit 11 may read the variances of the deviation calculated in operation 106 from the predetermined area of the RAM 7 and may determine a power ratio (Po/Pm) having a minimum variance value in operation S107. After the power ratio (Po/Pm) is determined, a write operation may be performed by using the determined power ratio (Po/Pm).

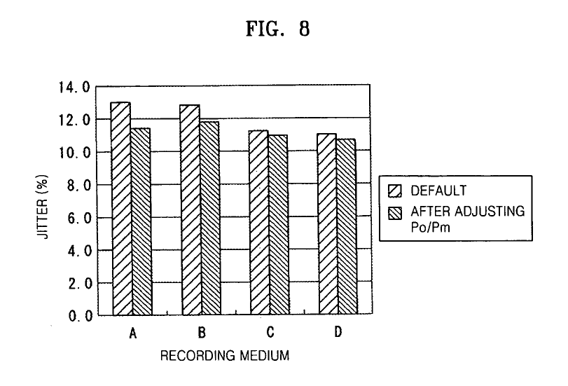

FIG. 8 illustrates the effect of an embodiment of the present invention.

As can be seen in FIG. 8, a reproduction jitter value when marks and spaces are written on optical media A through D with a write power in which the power ratio (Po/Pm) is adjusted according to the present invention is smaller than a reproduction jitter value when marks and spaces are written on optical media A through D with a write power having a default power ratio (Po/Pm). That is, with respect to any optical recording media, a reproduction jitter value can be lowered by applying a write power, in which the power ratio (Po/Pm) is adjusted according to the present invention, and performing a write operation.

In the present invention, by performing at least two recording and reproducing operations having different ratios (Po/Pm), a suitable write power for an optical writing medium to be used can be set in a short time. Accordingly, unlike the conventional technology, many write operations of marks and spaces with varying the ratio (Po/Pm) do not need to be performed.

Though the write-once-type DVD±R is explained as an example of an optical recording medium, the present invention is not limited to this and can also be applied to a rewritable DVD±R. Also, in the present invention, several deviations corresponding to power ratios (Po/Pm) may be sampled in the straight line interpolation or extrapolation and by obtaining the variance value of each deviation, a minimum variance value can be obtained. Also, the variance of a deviation corresponding to each of two different power ratio (Po/Pm) may be obtained, and by comparing the variances to find a smaller one, a power ratio (Po/Pm) to obtain a next variance can be determined sequentially such that a power ratio (Po/Pm) having a minimum variance value can be obtained.

According to the present invention, by performing at least two information recording and reproducing operations with varying the ratio (Po/Pm) of the first power (top power Po) to the second power (middle power Pm), a suitable write power for an optical writing medium to be used can be set in a short time.

Exemplary embodiments of the present invention have been disclosed herein, and although specific terms are employed, they are used and are to be interpreted in a generic and descriptive sense only and not for purpose of limitation. For example, the setting of a write strategy of the present invention may be implemented in software, e.g., by an article of manufacture having a machine-accessible medium including data that, when accessed by a machine, cause the machine to generate writing strategies in accordance with methods of the present invention. Accordingly, it will be understood by those of ordinary skill in the art that various changes in form and details may be made without departing from the spirit and scope of the present invention as set forth in the following claims.

What is claimed is:

1. A method of setting a write power for an optical writing apparatus for writing information on an optical recording medium using one of a write pulse having a first power level and a write pulse having a pulse in which the central part of the pulse has a second power level lower than the first power level, the method comprising:
setting a first power ratio of the first power level to the second power level;
directing a write pulse corresponding to the first power ratio onto the optical recording medium;
calculating, for each mark, first deviation values between a desired theoretical length of the mark and an actually formed written length of the mark;
setting a second power ratio of the first power level to the second power level;
directing a write pulse corresponding to the second power ratio onto the optical recording medium;
calculating, for each mark, second deviation values between a theoretical length of the mark and a written length of the mark;
estimating the deviation for each mark at a power ratio other than the first and second power ratios based on the first deviation values and the second deviation values;
calculating a variance value of the deviation at each power ratio; and
setting the first power level and the second power level by applying a power ratio corresponding to a minimum variance value among the calculated variance values.

2. The method as claimed in claim 1, wherein the estimating comprises performing a linear interpolation based on the first deviation values and the second deviation values.

3. The method as claimed in claim 2, wherein the linear interpolation includes weighting the deviations in accordance with a probability of occurrence of a mark.

4. An optical writing apparatus for writing information on an optical recording medium using one of a write pulse having a first power level and a write pulse having a pulse in which the central part of the pulse has a second power level lower than the first power level, the apparatus comprising:
a light source driving unit, when at least two different power ratios of the first power level to the second power level are set, outputting a pulse signal according to each power ratio to the light source for driving the light source;
a deviation calculation unit, when a write pulse to which each of the at least two different power ratios is applied is directed onto the optical recording medium, calculating a deviation for each mark with respect to each of the at least two different power ratios between a desired theoretical length of the mark and an actually formed written length of the mark;
a control unit estimating a deviation of a power ratio, other than the at least two different power ratios, for each mark based on calculated deviations from the deviation calculation unit with respect to each of the at least two different power ratios;
a variance calculation unit calculating the variance value of the deviation at each power ratio from the calculated deviations by the deviation calculation unit and estimated deviations by the control unit; and
a write power setting unit setting the first power level and the second power level by applying a power ratio corresponding to a minimum variance value among the calculated variance values.

5. The apparatus as claimed in claim 4, wherein the control unit estimates the deviation at the power ratio other than the at least two different power ratios by performing a linear interpolation based on the calculated deviations by the deviation calculation unit with respect to each of the at least two different power ratios.

6. The apparatus as claimed in claim 5, wherein the linear interpolation includes weighting the deviations in accordance with a probability of occurrence of a mark.

7. An article of manufacture having a machine-accessible medium including data that, when accessed by a machine, cause the machine to operate an optical information recording apparatus for writing information on an optical recording medium using one of a write pulse having a first power level and a write pulse light having a pulse in which the central part of the pulse has a second power level lower than the first power level, the operation comprising:
setting a first power ratio of the first power level to the second power level;
directing a write pulse corresponding to the first power ratio onto the optical recording medium;
calculating, for each mark, first deviation values between a desired theoretical length of the mark and an actually formed written length of the mark;
setting a second power ratio of the first power level to the second power level;
directing a write pulse corresponding to the set second power ratio onto the optical recording medium;
calculating, for each mark, second deviation values between a theoretical length of the mark and a written length of the mark;
estimating the deviation for each mark at a power ratio other than the first and second power ratios based on the first deviation values and the second deviation values;
calculating a variance value of the deviation at each power ratio; and
setting the first power level and the second power level by applying a power ratio corresponding to a minimum variance value among the calculated variance values.

8. The article as claimed in claim 7, wherein the estimating comprises performing a linear interpolation based on the first deviation values and the second deviation values.

9. The article as claimed in claim 8, wherein the linear interpolation includes weighting the deviations in accordance with a probability of occurrence of a mark.
